(19) United States
(12) Patent Application Publication
(10) Pub. No.: US 2005/0229733 A1
(43) Pub. Date: Oct. 20, 2005

(54) Rack-and-pinion steering system

(75) Inventors: Jurgen Osterlanger, Emskirchen (DE); Alexander Zernickel, Herzogenaurach (DE); Manfred Kraus, Herzogenaurach (DE); Stefan Willared, Erlangen (DE); Horst Munck, Herzogenaurach (DE)

Correspondence Address: OSTROLENK FABER GERB & SOFFEN, 1180 AVENUE OF THE AMERICAS, NEW YORK, NY, 100368403, US

(73) Assignee: INA-SCHAEFFLER KG

(21) Appl. No.: 11/074,171

(22) Filed: Mar. 7, 2005

(30) Foreign Application Priority Data
Mar. 5, 2004 (DE) 10 2004 010 819.6

(51) Int. Cl. F16H 55/28

(52) U.S. Cl. 74/422; 74/409

(57) ABSTRACT

A gear rack for a rack-and-pinion steering system for a motor vehicle is distinguished in that the bearing surface is configured as a recess situated within the circular gear rack. These bearing surfaces being are borne against by roller-mounted guide rollers with corresponding bearing surfaces.

### FIELD OF THE INVENTION

The present invention relates to a rack-and-pinion steering system for a motor vehicle, having a steering gear housing, in which a gear rack is mounted in a longitudinally displaceable manner, and having a pinion, which meshes with the gear rack, and a pressure part, which is disposed on a side of the gear rack lying opposite an engagement side with the pinion and which is preloaded with the aid of a spring in the axial direction against the gear rack. The pressure part has inside it a rotatable guide roller matched to the contour of the gear rack and has a bearing surface against which the gear rack bears with a corresponding bearing surface. The bearing surfaces are disposed relative to each other in such a way that the gear rack is prevented from being twisted in the peripheral direction.

### BACKGROUND OF THE INVENTION

Rack-and-pinion steering systems of this type have long been known from the prior art. In these steering systems, the gear rack is guided displaceably in the longitudinal direction in a steering gear housing. A pinion, rotatably mounted in the steering gear housing, engages in the toothing of the gear rack and, upon turning of the steering column connected in a rotationally secure manner to the pinion, brings about the lateral displacement of the gear rack, which, in turn, via tie rods and steering knuckles, causes the steered wheels of the motor vehicle to swivel. The engagement of the pinion in the gear rack is kept free from backlash, in that a pressure part, which bears opposite the pinion against the gear rack, forces the gear rack against the pinion under spring preload. In this context, the pressure part must, on the one hand, be able to transmit the necessary pressure force and, on the other hand, offer a bearing face which, upon the displacement of the gear rack, produces no significant friction forces and no substantial wear on the pressure part. If, now, the steering force applied by the driver via the pinion is amplified by a ball screw, then, as a result of the torque transmission, the gear rack will be tempted to twist over its axial length in the peripheral direction. An attempt is made to prevent this by arranging the bearing surfaces of guide roller and gear rack in such a way relative to each other that they stop the gear rack from being twisted.

A rack-and-pinion steering system of this type is known from DE 82 03 943 U. As shown by FIG. 5 of this prior publication, the gear rack has two bearing surfaces, which are inclined symmetrically towards the toothing plane. The rack-and-pinion steering system further includes a guide roller, which is disposed in a pressure part and likewise has two bearing surfaces. The bearing surfaces of the gear rack are produced by the removal of material by machine-cutting from the, in the original state, round gear rack. The bearing surfaces of the guide roller are formed by two outer rings of a ball bearing, which are disposed in the pressure part and whose contacting surfaces, forming the bearing surfaces, are likewise symmetrically inclined in relation to the toothing plane. It is obvious that such positioning of the bearing surfaces of gear rack and guide roller prevents the gear rack from being twisted in the peripheral direction.

A drawback in this is the complex design of the bearing surfaces of gear rack and guide roller. On the one hand, the machine-cutting of the gear rack is complex and hence expensive, since a considerable material component has to be removed. On the other hand, the pressure part is of very complicated construction and hence also expensive. For instance, two ball bearings have to be accommodated in the pressure part with a bolt each, which places high demands on the assembly and, in addition thereto, lays claim to additional construction space.

### SUMMARY OF THE INVENTION

Starting from the drawbacks of the known prior art, the object of the invention is therefore to provide a substantially simplified rack-and-pinion steering system with a pressure part, which is simple to produce and can reliably absorb torques, radial and axial forces, while offering high load-bearing capacity.

According to the invention, this object is achieved by the fact that the bearing surface of the gear rack is configured as a recess situated within the circular gear rack. Within the meaning of the invention, this should be taken to mean that in the lower part of the gear rack, i.e. in the region of the guide roller, the circle perimeter or periphery thereof is only slightly interrupted.

This offers the advantage that the recess serving as a bearing surface can be incorporated into the gear rack by a simple machine-cutting process, for example by milling. The round cross-sectional profile of the gear rack is thereby substantially preserved. It is therefore no longer necessary, as per the prior art, to remove loads of material by machine-cutting in order to produce the bearing surfaces.

Further advantageous designs of the invention are described.

For instance, the bearing surface of the gear rack is intended to be of semicircular or V-shaped configuration. The two embodiments are on a par and, because of their uncomplicated geometric cross-sectional shape, can also be easily introduced into the gear rack.

According to a further feature of the invention, it is envisaged that the guide roller may be held by two angular-contact roller bearings, which are spaced apart in the axial direction, while, these may be configured as angular-contact needle bearings, which are set relative to each other in O or X arrangement. As a result of these mutually set angular-contact roller bearings, both radial and axial forces, as well as torques, are able to be reliably absorbed.

According to a further feature of the invention, the guide roller is intended to be configured as a rotationally symmetrical body, having bearing surfaces which are inclined symmetrically to its rotation axis and the extensions of which meet at a radially outer point.

According to a further feature, the pressure part is intended to be configured in two parts and to be held together either by a fastening screw or by a fastening pin. Within the meaning of the invention, a fastening screw should be perceived as a connecting element which is inserted from the outside, while a connecting pin is inserted from the inside.

According to a further feature of the invention, the pressure part is intended to be made of a plastic. These types of pressure parts, on the one hand, have a specifically lighter weight and, on the other hand, also exhibit relatively good sliding characteristics in a receiving bore which surrounds them.

If such a pressure part is made of plastic, then, it may be expedient for both halves of the pressure part to form a raceway for the mutually spaced angular-contact roller bearings, in the form of an insert.

A different type of guide roller is configured as a two-part rotationally symmetrical body having bearing surfaces which are inclined symmetrically to its rotation axis and the extensions of the bearing surfaces meet at a radially inner point. The two-part body of rotationally symmetrical configuration is concentrically enclosed by an outer ring having corresponding bearing surfaces likewise inclined symmetrically to the rotation axis.

On both sides of this two-part guide roller of rotationally symmetrical configuration there is advantageously disposed a spring element, which subjects the guide roller to an axial force. The desired bearing preload can thereby be set in an uncomplicated fashion.

Finally, according to one last feature of the invention, the pressure part is intended to be provided on its contacting surface with a circumferential recess, into which an O-ring is inserted.

The invention is explained in greater detail below with reference to the following illustrative embodiments.

### BRIEF DESCRIPTION OF THE DRAWING(S)

FIGS. 1, 2 and 3 show a longitudinal section through a pressure part, designed according to the invention, with gear rack, and

FIG. 4 shows a top view of a pressure part according to FIG. 3, and

FIG. 5 shows a longitudinal section through a pressure part with gear rack according to the prior art.

### DETAILED DESCRIPTION OF EMBODIMENTS OF THE INVENTION

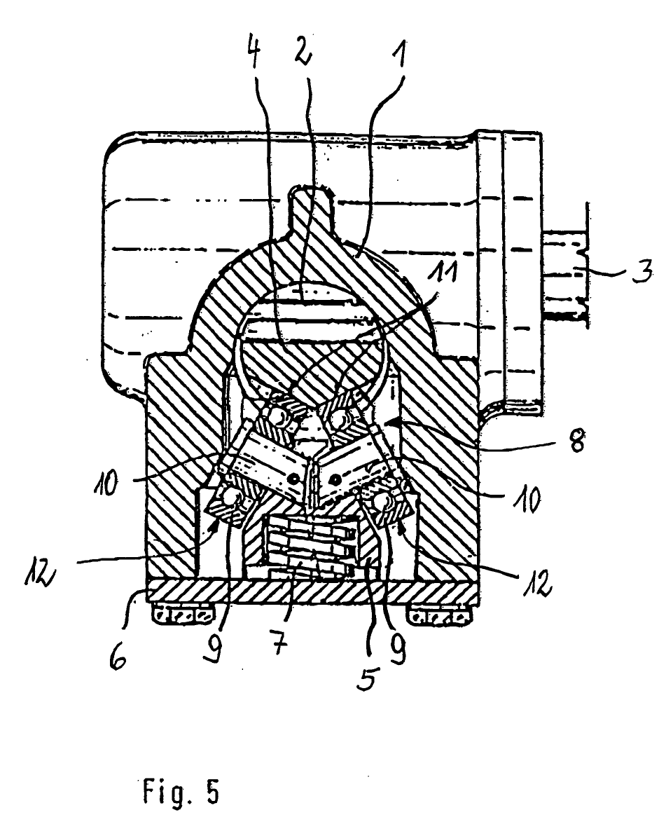

In order to present the overall context, reference shall first be made to the prior art according to FIG. 5. This shows a housing 1, in which a pinion 2, which passes into a steering spindle 3, is mounted. Engaging in the toothing of the pinion 2 is the toothing of a gear rack 4, which runs transversely to the pinion 2. On that side of the gear rack 4 lying opposite the engagement side of the pinion 2 with the gear rack 4 there is disposed a pressure part 5, which substantially supports the force transmitted by the pinion 2 to the gear rack 4. The pressure part 5 is accommodated in a receiving bore (not labeled) in the housing 1. It is preloaded in the direction of the gear rack 4 by a spring 7 disposed between the pressure part 5 and a cover 6 rigidly connected to the housing 1.

Accommodated in the pressure part 5 there is a guide roller 8, comprised of two roller bearings 9, each configured as deep-groove ball bearing and each held on a respective bearing axle 10. The bearing axles 10 and hence the roller bearings 9 are disposed at a certain angle to the toothing plane, so that the obliquely set outer rings of the roller bearings 9 bear with their bearing surfaces 12 against the bearing surfaces (denoted by 11) of the gear rack 4. It is obvious that the gear rack 4 cannot move in the peripheral direction should a torque be applied, for example by a ball screw.

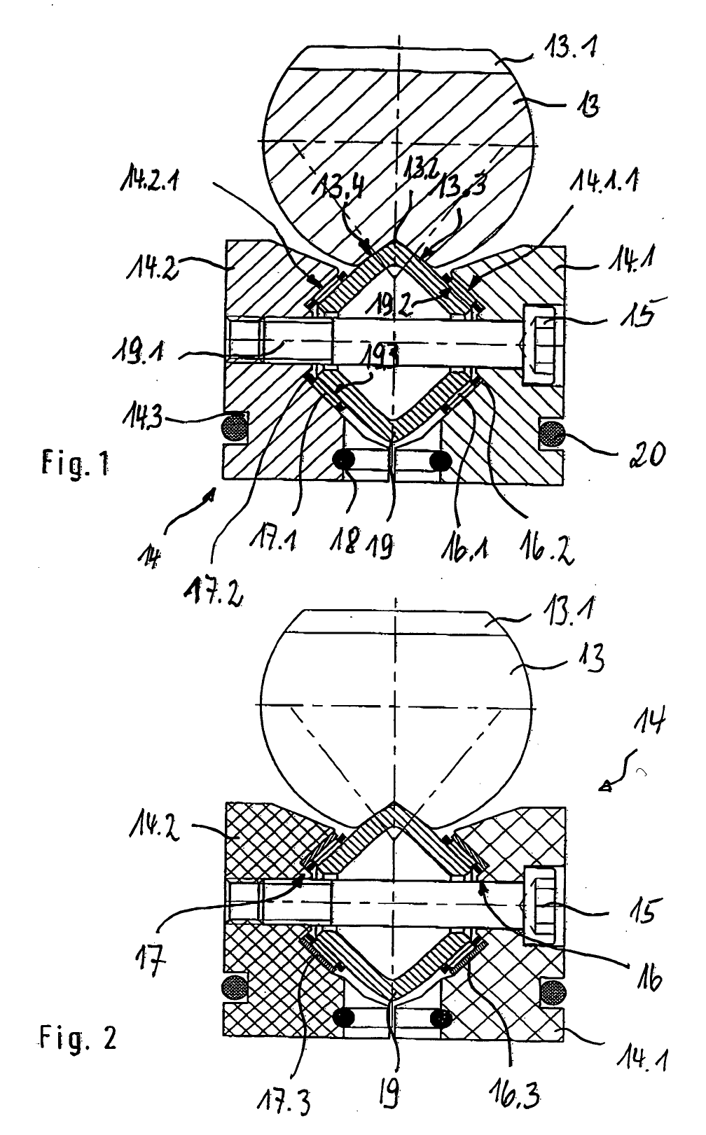

In FIG. 1, an inventive arrangement of a pressure part 14 and a gear rack 13 is shown, the gear rack 13, on its side facing away from the pressure part 14, being provided according to the prior art with a toothing 13.1, in which a pinion (not represented) engages. On its side lying opposite the toothing 13.1, the gear rack 13 has a recess 13.2, which, in the illustrative embodiment, is of V-shaped configuration, with the result that two bearing surfaces 13.3, 13.4 are formed, which are inclined symmetrically to the toothing 13.1. The pressure part 14 comprises the two halves 14.1, 14.2, which are held together by a fastening screw 15. Rotatably mounted in the pressure part 14 is the guide roller 19, the rotation axis 19.1 of which is simultaneously the center axis of the fastening screw 15. The guide roller 19 is configured as a rotationally symmetrical body, having bearing surfaces 19.2, 19.3 which are mutually inclined symmetrical to its rotation axis 19.1 and which come together at a radially outer point. As the figure further reveals, the guide roller 19 has the greatest diameter in its center, which diameter constantly decreases in both axial directions. The guide roller 19 is held rotatably in the pressure part 14 by the two mutually spaced angular-contact needle bearings 16, 17, the bearing needles 16.1, 17.1 being guided in a respective cage 16.2, 17.2. The raceways of the angular-contact needle bearings 16, 17 are formed, on the one hand, by the bearing surfaces 19.2, 19.3 of the guide roller 19 and, on the other hand, by the surfaces 14.1.1, 14.2.1 of the pressure part halves 14.1, 14.2, which surfaces likewise run at a mutually symmetrical inclination. The angular-contact needle bearings 16, 17 are set relative to each other in an X-arrangement, i.e. their pressure lines run obliquely from outer to inner in the direction of the center point of the guide roller 19. The arrangement further includes a spring 18, which forces the pressure part 14 against the gear rack 13, and an O-ring 20, which is disposed in a groove 14.3 in the pressure part 14. If, now, the gear rack 13 is laterally displaced by means of a pinion (not represented), then it is supported on the guide roller 19, which is thereby set in rotation about the fastening screw 15 by which it is penetrated, the support being realized by means of the two angular-contact needle bearings 16, 17.

As further revealed by FIG. 1, a desired bearing preload can be set by the two halves 14.1, 14.2 of the pressure part 14, and hence the bearing surfaces 19.2, 19.3 and the raceways 14.1.1, 14.2.1, being moved closer together by tightening of the fastening screw 15.

A unit consisting of pressure part 14 and gear rack 13 is thereby created, which is distinguished by the following advantages:
low-cost manufacture and assembly
low loss friction and low running noise
reliable absorption of axial and radial forces and of acting torques
high load-bearing capacity.

The pressure part 14 shown in FIG. 2 differs from that shown in FIG. 1 merely by the fact that the raceways 14.1.1, 14.2.1 are not formed by the two halves 14.1, 14.2 of the pressure part 14, but by inserts in the form of metal running disks 16.3, 17.3. These are used, in particular, where the pressure part 14 is made of a non-metallic material, for example of a plastic.

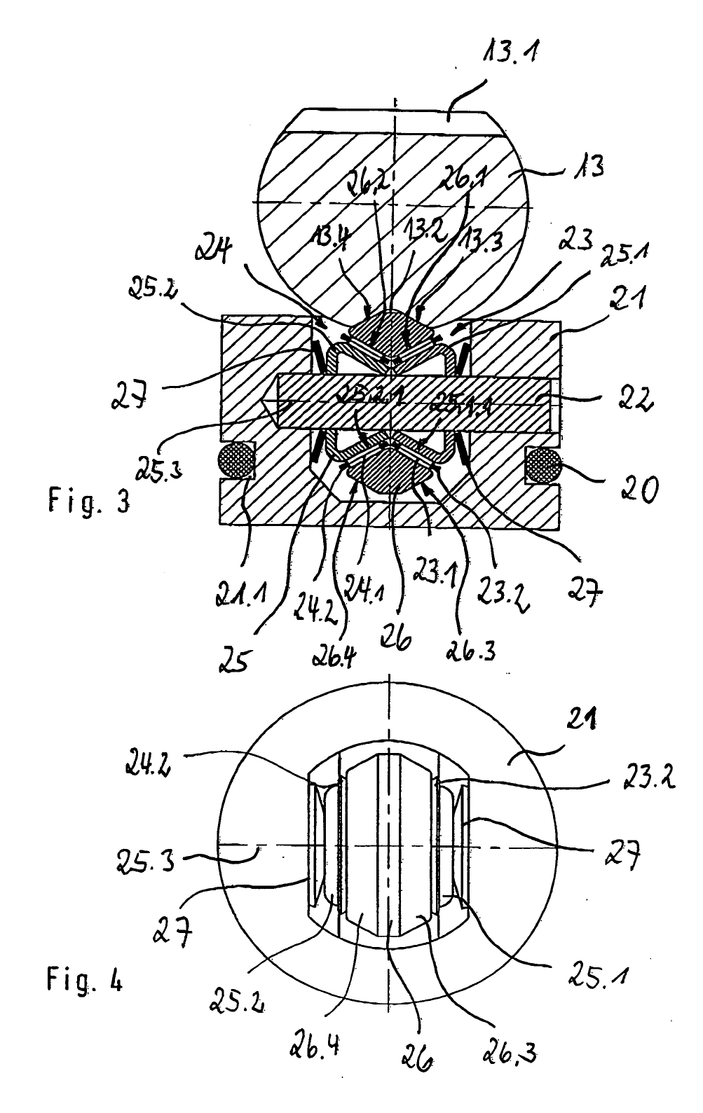

The pressure part, which in FIGS. 3 and 4 is provided with the reference numeral 21, is configured in one piece and has a guide roller 25, which is held within the pressure part 21 by means of a fastening pin 22. This is of two-part configuration and consists of the two parts 25.1, 25.2, the bearing surfaces 25.1.1, 25.2.1 of which are inclined symmetrically to each other and meet at a radially inner point. In other words, the diameter of the guide roller 25 decreases from outer to inner. The pressure part 21 also includes the outer ring 26, having a prismatic profile which, on the one hand, is matched to the bearing surfaces 13.3, 13.4 of the gear rack 13 and, on the other hand, to the bearing surfaces 25.1.1, 25.2.1 of the parts 25.1, 25.2. In this way, inner and outer bearing surfaces 26.1, 26.2, 26.3, 26.4 of the outer ring 26 are formed, which likewise run at a mutually symmetrical inclination. Disposed between the bearing surfaces 25.1.1, 25.2.1, 26.1, 26.2 are the two angular-contact needle bearings 23, 24, which are set relative to each other in O-arrangement, i.e. their pressure lines run obliquely from inner to outer. Finally, the spring element 27 in the form of a cup spring forms part of the pressure part 21 configured according to the invention, these bilateral spring elements 27 moving the two halves 25.1 and 25.2 of the guide roller 25 closer together and, by their bearing surfaces 25.1.1, 25.2.1, forcing the bearing needles 23.1, 24.1 against the inner bearing surfaces 26.1, 26.2 of the outer ring. A desired preload can thus easily be set in the guide roller unit.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A rack-and-pinion steering system for a motor vehicle, comprising;
a steering gear housing;
a gear rack mounted in a longitudinally displaceable manner in the housing;
a pinion having an engagement side which meshes with the gear rack;
a pressure part disposed on an opposed side of the gear rack lying opposite an engagement side with the pinion; a spring preloading pressure in the axial direction against the gear rack;
the pressure part having inside it a rotatable guide roller matched to the contour of the gear rack and also having a bearing surface against which the gear rack bears with a corresponding bearing surface, the bearing surfaces being disposed relative to each other in such a way that the gear rack is prevented from being twisted in a peripheral direction;
the bearing surface is configured to define at least one recess situated within the circular gear rack.

2. The rack-and-pinion steering system according to claim 1, wherein the recess of the gear rack is of a semicircular configuration.

3. The rack-and-pinion steering system according to claim 1, wherein the recess of the gear rack is of a V-shaped configuration.

4. The rack-and-pinion steering system of claim 1, further comprising the guide roller having an axial direction; two angular-contact roller bearings, which are spaced apart in the axial direction and which hold the guide roller.

5. The rack-and-pinion steering system according to claim 4, wherein the angular-contact roller bearings comprise angular-contact needle bearings, which are set relative to each other in an O or an X arrangement.

6. The rack-and-pinion steering system according to claim 1, wherein the guide roller comprises a rotationally symmetrical body having bearing surfaces which are inclined symmetrically to a rotation axis of the guide roller and the bearing surfaces have extensions which meet at a radially outer point.

7. The rack-and-pinion steering system of claim 1, wherein the pressure part is configured in two parts; a fastening screw or a fastening pin holding the two parts together.

8. The rack-and-pinion steering system according to claim 1, wherein the pressure part is made of a plastic.

9. The rack-and-pinion steering system according to claim 1, wherein the pressure part has two halves, each forming a respective raceway for one of the mutually spaced angular-contact roller bearings, and the raceway in the form of an insert.

10. The rack-and-pinion steering system according to claim 1, wherein the guide roller comprises a two-part rotationally symmetrical body having bearing surfaces which are inclined symmetrically to the rotation axis of the roller, and the bearing surfaces including respective extensions which meet at a radially inner point;
an outer ring concentrically enclosing the two-part body of rotationally symmetrical configuration and the two-part body having corresponding bearing surfaces likewise inclined symmetrically to the rotation axis.

11. The rack-and-pinion steering system according to claim 10, further comprising a spring element subjecting the two-part body of rotationally symmetrical configuration to an axial force on both sides thereof.

12. The rack-and-pinion steering system according to claim 1, wherein the pressure part includes a contacting surface having a circumferential recess, and an O-ring inserted into the recess.
